(19) United States
(12) Patent Application Publication
(10) Pub. No.: US 2024/0367647 A1
(43) Pub. Date: Nov. 7, 2024

(54) DEVICE AND METHOD FOR DETECTING A VEHICLE EXITING ITS LANE

(71) Applicant: Continental Autonomous Mobility Germany GmbH, Ingolstadt (DE)

(72) Inventor: Jérémy Leduc, Toulouse (FR)

(21) Appl. No.: 18/580,394

(22) PCT Filed: Jul. 15, 2022
(86) PCT No.: PCT/EP2022/069859

§ 371 Date: Jan. 18, 2024

(30) Foreign Application Priority Data
Jul. 20, 2021 (FR) 2107818

(51) Int. Cl. B60W 30/095; B60W 50/14

(52) U.S. Cl. CPC B60W 30/095; B60W 50/14; B60W 2420/408; B60W 2520/125

(57) ABSTRACT

A device for detecting a lane departure of a vehicle. The device being configured, when the vehicle is traveling on a road including at least one traffic lane, to: estimate, on the basis of the shape and position of at least one road boundary, the shape and position of each boundary of the lane taken by the vehicle; estimate a path followed by the vehicle; determine, depending on the shape and on the position of the boundaries of the traffic lane, and on the path followed by the vehicle, a time interval before the vehicle will reach one of the boundaries of the traffic lane; and compare the time interval to a determined threshold and, if the time interval is less than the threshold, determine that the vehicle is in the process of departing from its lane.

### CROSS REFERENCE TO RELATED APPLICATIONS

This application is the U.S. National Phase application of PCT International Application No. PCT/EP2022/069859, filed Jul. 15, 2022, which claims priority to French Patent Application No. 2107818, filed Jul. 20, 2021, the contents of such applications being incorporated by reference herein.

### FIELD OF THE INVENTION

The present disclosure relates to a device and a method for detecting and even predicting a lane departure of a land vehicle. This disclosure applies to a vehicle that is not equipped with a sensor capable of detecting road marking lines.

### BACKGROUND OF THE INVENTION

Land vehicles, in particular cars, heavy goods vehicles, etc., increasingly include driving assistance functions designed to alert a driver to certain dangers, or even assist or replace the driver in controlling the vehicle.

In this context, it is useful to be able to detect, as soon as possible, that a vehicle is in the process of departing from its traffic lane, or even the road, so that, if necessary, if the lane departure is not desired, the driver can be alerted or the departure prevented.

To this end, lane change detection algorithms are already known. For example, document U.S. Pat. No. 10,406,980, incorporated herein by reference, discloses a system for detecting a lane change of a vehicle, which comprises a camera positioned at the front of the vehicle, a radar sensor and a computer, which detects road markings (lane separation lines) in the images acquired by the camera, determines whether the vehicle is in the process of changing lane, depending on whether the vehicle is approaching a lane separation line, and uses the radar to detect a risk of collision with a vehicle located in an adjacent lane.

However, some vehicles are not necessarily provided with a camera capable of acquiring images in which road markings are visible. In this type of vehicle, it is not possible to implement this type of method of lane detection based on the analysis of road markings. Moreover, even when the vehicle is equipped with a camera, some roads (secondary roads, road repair work, etc.) are not always provided with markings.

Also disclosed by document U.S. Pat. No. 10,586,455, incorporated herein by reference, is a lane change detection method implemented by a device comprising a radar sensor and a computer, the method comprising calculating a path of the vehicle, identifying an inflection point in the path of the vehicle, and using the identification of the inflection point to confirm a lane change of the vehicle.

However, the inflection point in the path of the vehicle can only be detected when the vehicle has already changed lane, or is in the process of changing lane. This method cannot be used to detect a change of lane before it takes place.

### SUMMARY OF THE INVENTION

The present disclosure is intended to improve the situation.

In particular, an aspect of the present disclosure is a device and a method for detecting a lane departure even when there is no camera in the vehicle. Another aspect of the present disclosure is to make it possible to detect a lane departure before this departure has taken place.

An aspect of the invention proposes a device for detecting a lane departure of a land vehicle, comprising a radar installed in the vehicle, the radar being capable of acquiring information relating to the surroundings of the vehicle that can be used to estimate the shape and the position of at least one boundary of the road on which the vehicle is traveling, and at least one computer, the prediction device being characterized in that it is configured, when the vehicle is traveling on a road comprising at least one traffic lane, to:
a. estimate, on the basis of the shape and the position of at least one boundary of a road on which the vehicle is traveling, the shape and the position of each boundary of the traffic lane taken by the vehicle, to either side of it,
b. estimate a path followed by the vehicle,
c. determine, depending on the shape and on the position of the boundaries of the traffic lane, and on the path followed by the vehicle, a time interval before the vehicle will reach one of the boundaries of the traffic lane,
d. compare the time interval to a determined threshold and, if the time interval is less than the threshold, determine that the vehicle is in the process of departing from its traffic lane,
   the device being further configured to estimate, from data acquired by the radar, the shape and the position of at least one road boundary, by using a clothoid curve, a width of the traffic lanes and the number of traffic lanes of the road, and to deduce therefrom the shape and the position of each boundary of the traffic lane taken by the vehicle.

In embodiments, the device is configured to determine said time interval by determining a point of intersection between a boundary of the lane and the path of the vehicle, and by calculating the time interval required by the vehicle to reach said point of intersection.

In embodiments, if the path of the vehicle has a point of intersection with each of the boundaries of the traffic lane, the device is configured to select the point of intersection closest to the vehicle.

In embodiments, the device is configured to calculate a distance to be traveled by the vehicle between its current position and the point of intersection, and to deduce therefrom the time interval required by the vehicle to reach the point of intersection, taking into account the speed of the vehicle and its acceleration.

In embodiments, the device is configured to implement steps a. to d. iteratively, and, in a first iteration, to:
estimate the path followed by the vehicle, assuming that the vehicle is in the middle of its traffic lane,
if the time interval is greater than the first determined threshold but less than a second determined threshold greater than the first threshold, determine a lateral movement of the vehicle in its lane and update, for the next iteration, the lateral positions of the boundaries of its traffic lane in relation to the vehicle.

A device according to any one of the preceding features, configured, if the time interval is less than the first determined threshold, to implement at least one action from the following group:
generate a lane departure warning for a driver of the vehicle,
generate instructions to modify the path of the vehicle in order to keep the vehicle in the lane,
generate instructions to slow down the vehicle.

In embodiments, the radar is an optical radar (i.e., lidar).

According to another aspect, the invention describes a method for detecting a lane departure of a land vehicle, implemented by a device according to the above description, characterized in that it comprises:
estimating the shape and the position of each boundary of a traffic lane taken by the vehicle, on the basis of the shape and the position of at least one boundary of the road containing the traffic lane,
estimating a path followed by the vehicle,
determining, depending on the shape and the position of the boundaries of the traffic lane, and the path followed by the vehicle, a time interval before the vehicle reaches a boundary of the traffic lane, and
comparing the time interval to a determined threshold and, if the time interval is less than said threshold, determining that the vehicle is in the process of departing from or is going to depart from its traffic lane.

According to another aspect, the invention describes a computer program product, comprising code instructions for implementing the method described above, when this program is executed by a processor.

According to another aspect, the invention describes a non-transitory computer-readable recording medium on which a program is recorded for implementing the method described above when this program is executed by a processor.

The proposed device can be implemented in a vehicle without a camera for obtaining images of the road, because it only requires the use of a radar that can be used to detect the edges of the road, which radar can be an optical radar (i.e., a lidar). The device can also be used in a vehicle that normally uses road markings to detect a lane departure, when the vehicle is traveling on a road whose road markings are absent or poorly visible.

This device makes it possible to predict a lane departure, whether this is a lane change or a departure from the road, before this departure actually takes place, based on a lane departure point calculated by the device and a time interval remaining before the vehicle reaches the lane departure point.

This device can therefore be used to alert a driver to his or her path before the lane departure takes place, or to control the activation of other driver assistance functions linked to a possible lane change.

### BRIEF DESCRIPTION OF THE DRAWINGS

Other features, details and advantages will become apparent from reading the following detailed description and from analyzing the appended drawings, in which:

FIG. 1 schematically shows a vehicle fitted with a device according to one embodiment, and notation conventions for estimating the path of the vehicle and the shape and the position of the edges of the lane and/or road.

FIG. 2 schematically shows the notation conventions used to determine the distance to be traveled by the vehicle in order to reach a point of intersection between a lane edge and the path of the vehicle.

FIG. 3 schematically shows the notation conventions used to calculate a lateral movement of the vehicle.

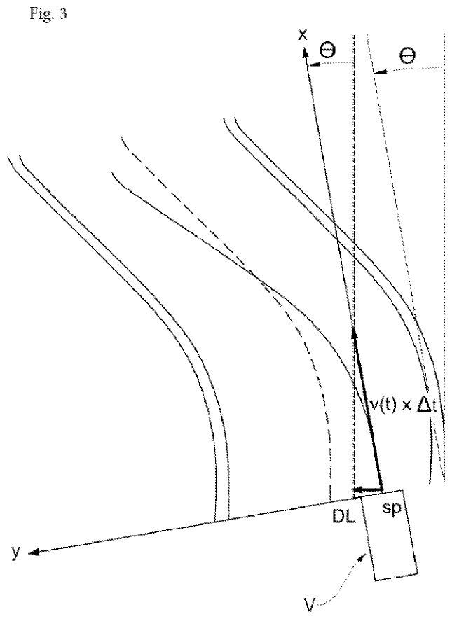

FIG. 4 schematically shows the main steps of a method implemented by a device for detecting a lane departure according to one embodiment.

### DETAILED DESCRIPTION OF THE PREFERRED EMBODIMENTS

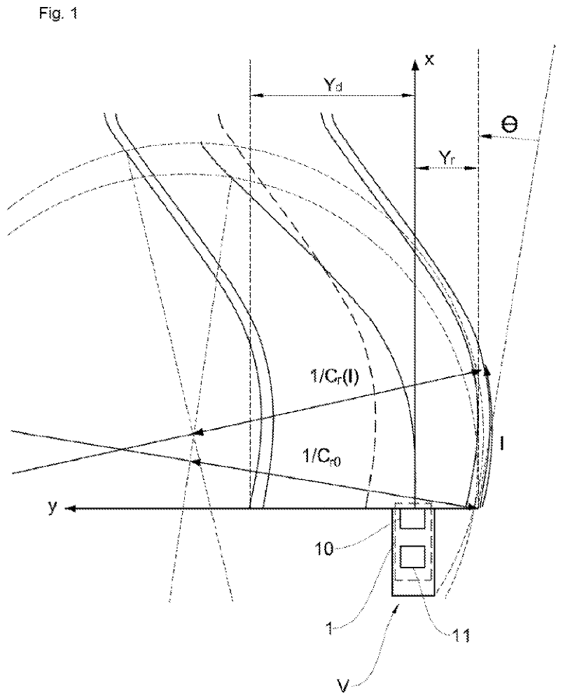

Reference is now made to FIG. 1, which shows a land vehicle V, typically a motor vehicle, a two-wheeled vehicle, a heavy goods vehicle, etc., incorporating a lane departure detection device 1. This device comprises a radar 10 installed in the vehicle, capable of acquiring information relating to the surroundings of the vehicle that can be used to detect the edges of the road on which the vehicle is traveling. The radar 10 may also be an optical radar (or lidar). The device 1 further comprises at least one computer 11. The radar or lidar may comprise, as is known, a sensitive element comprising a radio wave transceiver in the case of a radar, or a laser beam in the case of an optical radar (lidar), and a computer capable of processing the signals acquired by the transceiver in order to deduce therefrom data that can be interpreted by humans or by another processing system. In embodiments, the computer 11 of the device 1 is combined with the computer of the radar 10, such that the lane departure detection device can be considered to be a radar or lidar 10 provided with additional detection functions.

As a variant, the computer 11 of the detection device 1 may be a computer separate from that of the sensor 10. It may, for example, be a processor, a controller, a microcontroller or any other type of computer suitable for implementing the processing operations described below.

If the computer of the detection device is separate from the radar, this computer is not necessarily installed in the vehicle. It may, for example, be a remote computer in communication with the vehicle via a telecommunication interface on a wireless communication network. In this case, lane change detection information obtained by the computer may be returned to the vehicle in order for certain actions described below to be implemented in the vehicle.

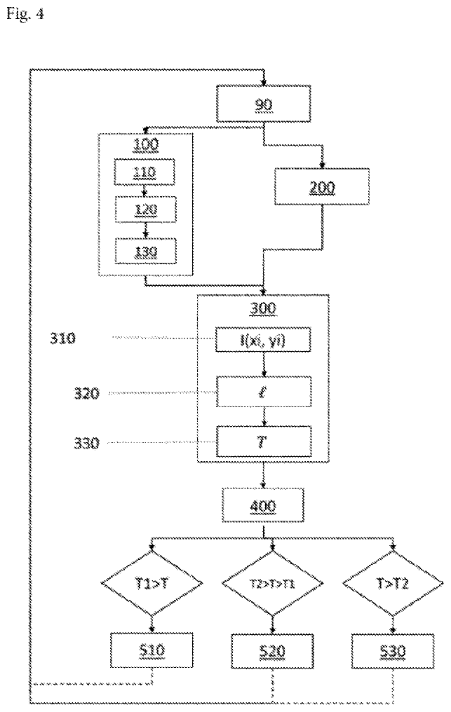

The lane departure detection device 1 is configured to implement a method for detecting a lane departure, the main steps of which are shown in FIG. 4. As described below in greater detail, this method is implemented iteratively. This method may, for example, be implemented at the same frequency as a frequency of the radar 10 for acquiring 90 data relating to the surroundings of the vehicle. For example, the method may be implemented at a frequency of between 1 and 50 Hz, for example of the order of 20 Hz, i.e., every 50 ms.

During this method, the device 1 is configured, while the vehicle is moving on a road which may comprise one or more traffic lanes, to estimate the shape and the position of the boundaries of the traffic lane taken by the vehicle during a step 100, from measurements taken by the radar 10 during a step 90.

Hereinafter, a boundary of a traffic lane may correspond to a road boundary, for example when the right-hand boundary of a traffic lane closest to the right-hand side of the road is being considered. A boundary of a traffic lane may also correspond to a delimitation between two adjacent traffic lanes, which may be, but is not necessarily, indicated on the road with a demarcation line. However, the lane detection device does not need to actually detect a delimitation indicated on the road in order to estimate the position of a traffic lane boundary.

In embodiments, the device 1 estimates the shape and the position of the two traffic lane boundaries situated to either side of the vehicle. This may be a road boundary on one side of the vehicle, and a boundary delimiting two adjacent traffic lanes on the other side of the vehicle. Alternatively, for a road comprising more than two traffic lanes, the two traffic lane boundaries to either side of the vehicle may be lane boundaries delimiting two adjacent traffic lanes.

During the step 100, the device 1 determines the shape and the position of the boundaries of the traffic lane taken by the vehicle, on the basis of the shape and the position of at least one road boundary containing the traffic lane, and the configuration of the road. The configuration of the road comprises the number of traffic lanes of the road, and a type of width of the traffic lanes in the road.

The step 100 comprises a step 110 of determining the shape and the position of at least one road boundary, and preferably of the two boundaries of the road on which the vehicle is traveling. In one embodiment, this step is implemented by the computer of the radar 10; as a variant, it is implemented by the computer 11 of the device 1.

In order to implement the lane departure detection method, the shape of a road boundary is estimated using a clothoid curve. This is a curve with a constant variation in curvature, defined by:

$${C}_{r} ( l ) = {C}_{r 0} + {C}_{r 1} ℓ$$

in which Cᵣ₀ represents the initial curvature of the curve, Cᵣ₁ represents the gradient of curvature as a function of the curvilinear distance from the origin; and [symbol] represents the curvilinear distance from the origin.

In an orthogonal reference frame (X, Y) centred on the vehicle, and more specifically centred on a point situated half-way across the front end of the vehicle, and shown in FIG. 1, each road boundary is represented by an equation of the following type:

$$y ( x ) = Y + θ x + \frac{{C}_{r 0}}{2} {x}^{2} + \frac{{C}_{r 1}}{6} {x}^{6}$$

in which Y represents the lateral position of the point of intersection between the curve defining the road boundary and the axis Y of the reference frame (X,Y), and θ represents the angle between the direction of movement of the vehicle and the tangent to the road or lane boundary. Y and θ are values measured by the radar and are unrelated to the forward travel x of the vehicle.

The device 1 can therefore determine the curvature and the gradient of curvature of each road boundary, in order to deduce therefrom a clothoid curve equation associated respectively with the left-hand boundary and the right-hand boundary. In certain cases, the curvature and the gradient of curvature of the left- and right-hand boundaries of the road may be identical.

The step 100 also comprises a step 120 of determining the configuration of the road, which comprises determining a number of lanes and a type of width of each lane of the road. For example, the traffic lanes may be classified into several categories, such as “normal width”, “narrow width” or “very narrow width”. An average lane width value may be associated with each category. The step 120 may be implemented either by the radar 10, by means of processing algorithms implemented by the computer of the radar 10, or by the computer 11.

The device 1 then determines 130, from at least one of the boundaries of the road and the determined configuration of the road, the shape and the position of the boundaries of lanes taken by the vehicle.

If the road only comprises a single traffic lane, the shape and the position of the lane boundaries correspond to those of the road boundaries.

If the number of lanes on the road is greater than 1, one of the lane boundaries may coincide with a road boundary, but at least one lane boundary is a boundary separating two traffic lanes. For this type of lane boundary, the device 1 estimates the shape and the position of the lane boundary separating two traffic lanes on the basis of the shape and the position of one of the road boundaries. To do this, the shape of a lane boundary separating two traffic lanes is approximated using the same equation as above. If two different equations are determined for the two left- and right-hand road boundaries, the following conventions are applied:
A lane boundary situated to the left of the vehicle (according to its direction of movement) has the same shape (curvature and gradient of curvature) as the boundary situated to the left of the vehicle,
A lane boundary situated to the right of the vehicle (according to its direction of movement) has the same shape as the boundary situated to the right of the vehicle.

The value of Y, which determines the lateral position of the point of intersection between the lane boundary in relation to the Y axis of the reference frame centred on the vehicle, is determined by assuming, by default, that the vehicle is in the middle of its own lane, and that this value is therefore equal to half of the width of the lane in which the vehicle is located. The width of the lane may be obtained by the radar because, as indicated above, this radar can determine a lane classification corresponding to the lane that has been taken, and deduce an associated width therefrom. Alternatively, if the lane width is not available, it can be set to the standard width of a lane (3.75 m).

To be more precise, however, if the lane boundary corresponds to a road boundary, the actual distance between the vehicle and the road boundary can be taken into account. In this way, a distance Y_{d} is obtained between the right-hand lane boundary and the vehicle, defined by:

$${Y}_{d} = Max ( - \frac{LW}{2} , - {B}_{d} )$$

in which B_{d} is the absolute value of the distance between the vehicle and the right-hand road boundary and LW is the width of the lane in which the vehicle is located. Y_{d} is a negative value with respect to the Y axis shown in FIG. 1.

Moreover, the distance Y_{g} between the left-hand lane boundary and the vehicle is defined (according to the notation conventions of FIG. 1) by:

$${Y}_{g} = Min ( \frac{LW}{2} , {B}_{g} )$$

in which B_{g} is absolute value of the distance between the vehicle and the left-hand road boundary and LW is the width of the lane in which the vehicle is located.

Therefore, to sum up, the device 1 determines, from information acquired by the radar on the shape and the position of at least one of the boundaries of the road, the shape and the position of the lane boundaries respectively situated to the left and right of the vehicle (relative to its direction of movement).

The radar 10 or the computer 11 is also configured to determine or receive, from the host vehicle, information relating to the dynamics of the vehicle, in particular including the speed and the acceleration of the vehicle, which can be used to estimate the path of the vehicle in the form of a simplified clothoid composed of a curvature and a gradient of the curvature of the path as a function of the distance traveled by the vehicle.

Therefore, using the information relating to the dynamics of the vehicle, the device 1 is configured, at the computer of the radar 10 or the computer 11, to estimate 200 the path of the vehicle, using the following equation:

$$y ( x ) = \frac{{C}_{e o}}{2} {x}^{2} + \frac{{C}_{e 1}}{6} {x}^{3}$$

in which Cₑ₀ is the estimated curvature of the path of the vehicle and Cₑ₁ is the estimated gradient of curvature of the path of the vehicle.

Steps 100 and 200 can be carried out in any order, as steps 100 and 200 only require the radar 10 or the computer 11 to have acquired the information relating to the position of the boundaries of the road and to the dynamics of the vehicle.

The computer 11 is configured to next determine 300, from the path of the vehicle and the equations defining the shape and the position of the lane boundaries in relation to the vehicle, a time interval before the vehicle reaches a traffic lane boundary. This time interval corresponds to the time taken by the vehicle to reach the point of intersection between its path and one of the boundaries of the lane in which the vehicle is located.

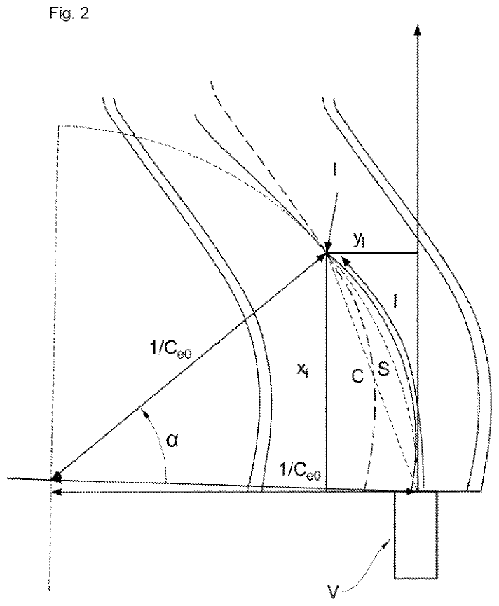

In order to do this, in reference to FIG. 2, the device 1 first determines 310 the coordinates (xᵢ, yᵢ) of the point of intersection I between the path of the vehicle and the one of the lane boundaries, by solving the following system of two equations and two unknowns:

$$\{ \begin{matrix}{y}_{i} ( {x}_{i} ) = \frac{{C}_{e o}}{2} {x}_{i}^{2} + \frac{{C}_{e 1}}{6} {x}_{i}^{3} \\ {y}_{i} ( {x}_{i} ) = Y + θ x + \frac{{C}_{r 0}}{2} {x}_{i}^{2} + \frac{{C}_{r 1}}{6} {x}_{i}^{6}\end{matrix}$$

This system may be solved, for example, using Cardan's method or Tschirnhaus' method.

Since the device 1 has two equations modeling the shape and the position respectively of the two lane boundaries, to the right and left of the vehicle, the number of solutions of this system may depend on the configuration of the road. Indeed, there may be scenarios in which several solutions are found.

In one embodiment, the device 1 calculates the solution or solutions of this system and, if several solutions are obtained, selects the point of intersection of the vehicle with a lane boundary situated in front of the vehicle and situated closest to the vehicle.

Therefore, if the two lane boundaries have the same shape, the device 1 calculates a single point of intersection with the lane boundary that intersects the path with a point of intersection whose xᵢ coordinate is positive.

If the two boundaries have a different shape, there are several scenarios. In one scenario, the device 1 does not determine any point of intersection between the path of the vehicle and a lane boundary with a positive xi coordinate. In this scenario, the processing operation implemented by the device to detect a lane departure ends without lane departure being detected.

In another scenario, the device 1 determines a single point of intersection between the path of the vehicle and one of the lane boundaries with a positive xi coordinate. In this scenario, this point of intersection is used for the subsequent processing operations.

In a final scenario, the device 1 determines two points of intersection whose x coordinate is positive between the path of the vehicle and each of the lane boundaries. In this scenario, the closest point of intersection, i.e., that which has the lowest x coordinate, is chosen for the subsequent processing operations.

As a variant, the device 1 may select just one of the two equations corresponding to one of the lane boundaries in order to solve the system indicated above. This boundary may be chosen, depending on its curvature and that of the vehicle, as being the boundary that the vehicle is most likely to cross. For example, if the two lane boundaries to either side of the vehicle are modeled with the same curvature Cᵣ₀ and the same gradient of curvature Cᵣ₁, in other words if the estimated curvature of the vehicle Cₑ₀ is greater than Cᵣ₀, according to the notation conventions shown in the figures, it is the lane boundary situated to the left of the vehicle that is likely to intersect the path of the vehicle. In this scenario, the device determines only a point of intersection between the path of the vehicle and the modeling of this lane boundary. Conversely, if Ce0<Cr0, an intersection is sought between the path of the vehicle and the lane boundary situated to the right of the vehicle, always in the direction of movement of the vehicle.

Once the point of intersection I (xi, yi) has been determined (and, if appropriate, selected), the device 1 determines 320 a distance [symbol] to be traveled by the vehicle in order to reach this point of intersection. In reference to FIG. 2, in order to simplify the calculations, this distance [symbol] is approximated by the length s of the smallest arc of the circle of radius 1/Cₑₒ passing through:
the origin of the reference frame, and
the point of intersection (xᵢ, yᵢ) between the path of the vehicle and the lane boundary that it intersects.
   By definition:

$$s = \frac{α}{{C}_{e 0}}$$

in which α is the angle formed between the normal to the path of the vehicle at the origin of the reference frame and the normal to the path of the vehicle at the point of intersection.

If c, the length of the arc chord, corresponds to the curvilinear length [symbol] , i.e., the straight line distance between the current position of the vehicle and the position of the point of intersection (xi, yi):

$$c = \sqrt{{x}_{i}^{2} + {y}_{i}^{2}}$$

Moreover, as can be deduced from the diagram in FIG. 2, the length c can also be calculated as follows:

$$c = \frac{2}{{C}_{e 0}} sin ( \frac{α}{2} )$$

Therefore, the distance [symbol] to be traveled in order to reach the point of intersection is calculated by applying the following formula:

$$ℓ \approx s = \frac{2}{{C}_{e 0}} arcsin ( \frac{{C}_{e 0} \sqrt{{x}_{i}^{2} + {y}_{i}^{2}}}{2} )$$

Finally, the computer 11 deduces 330 from this distance [symbol] the time T required by the vehicle to reach the point of intersection, from the distance and the speed of the vehicle. For greater accuracy, the calculation of the time required may also take into account a speed correction factor which takes into account the current acceleration of the vehicle:

$$T = \frac{ℓ}{V ( t ) + a ( t ) * Δ t}$$

in which V(t) is the instantaneous speed of the vehicle, a(t) is its instantaneous acceleration, and Δt is the time period between two iterations of the method.

The successive iterations of the method make it possible to monitor the change over time of this time T before the vehicle crosses a lane boundary.

In one embodiment, during a step 400, the device compares this time T to a predetermined threshold T1 and, if T is less than this threshold, it determines 510 that the vehicle is in the process of departing from its lane. T1 is preferably less than 5 seconds, and preferably between 1 and 3 seconds.

As a variant, and as shown in FIG. 4, T is compared to two thresholds T1 and T2, where T2 is greater than the threshold T1 determining the lane departure. T2 may, for example, be between 3 and 10 seconds.

In this case, when T drops below the threshold T2, this means that the vehicle is approaching the lane boundary in question and might depart from the lane. In this case, the device 1 updates 520, for subsequent iterations of the method, the lateral positions of the lane boundaries in relation to the vehicle, i.e., the values of Yg and Yd, taking into account a lateral movement of the vehicle in its lane. This lateral movement is determined from the instantaneous speed of the vehicle, and the initial angle measured between the vehicle and the road boundary that made it possible to determine the shape and the position of the lane boundary concerned by the time T before intersection. The lateral movement DL can be calculated as follows:

$$DL = sin ( θ ) * v ( t ) * Δ t$$

The update of the lateral positions of the lane boundaries is then obtained by:

$${Y}_{d , k + 1} = {Y}_{d , k} - DL$$

$${Y}_{r , k + 1} = {Y}_{r , k} + DL$$

in which k and k+1 denote two successive iterations of the method.

This update of the lateral position of the lane boundaries means, for the next iteration, a reduction in the time T before intersection with one of the boundaries. At each subsequent iteration, the device 1 continues to compare the time T to the two thresholds T1 and T2, and:
If T is between T2 and T1, the device 1 implements the same update 520 of the lateral position of the lane boundaries as described above,
If T is less than T1, the device 1 detects 510 a lane departure,
If T becomes greater than T2 again, the device 1 reinitializes 530 the values of Yg and Yd in accordance with the indications in the description of step 100 above.

When, during step 510, the device 1 detects a lane departure, it can transmit a signal to an on-board computer of the vehicle in order for the latter to generate an audio or visual warning for the driver of the vehicle. As a variant, the warning may be generated directly by the device 1. According to yet another variant, the lane departure information may be transmitted by the device 1 to the on-board computer of the vehicle in order to implement other reactions, including, for example, one of the following reactions:
generate instructions to modify the path of the vehicle in order to keep the vehicle in the lane,
generate instructions to slow down the vehicle.

The method therefore makes it possible to detect a lane departure of the vehicle, which may be a lane change or a departure from the road, before this departure has actually taken place, which makes it possible to take measures to prevent it. Moreover, this method can be adapted to different road configurations, and enables detection without analysis of road markings.

1. A device for detecting a lane departure of a land vehicle, comprising a radar installed in the vehicle, the radar being capable of acquiring information relating to the surroundings of the vehicle that can be used to estimate the shape and the position of at least one boundary of the road on which the vehicle is traveling, and at least one computer, the prediction device being configured, when the vehicle is traveling on a road comprising at least one traffic lane, to:
a. estimate, on the basis of the shape and the position of at least one boundary of a road on which the vehicle is traveling, the shape and the position of each boundary of the traffic lane taken by the vehicle, to either side of it,
b. estimate a path followed by the vehicle,
c. determine, depending on the shape and on the position of the boundaries of the traffic lane, and on the path followed by the vehicle, a time interval before the vehicle will reach one of the boundaries of the traffic lane, and
d. compare the time interval to a determined threshold and, if the time interval is less than the threshold, determine that the vehicle is in the process of departing from its traffic lane,
the device being further configured to estimate, from data acquired by the radar, the shape and the position of at least one road boundary, by using a clothoid curve, a width of the traffic lanes and the number of traffic lanes of the road, and to deduce therefrom the shape and the position of each boundary of the traffic lane taken by the vehicle.

2. The device as claimed in claim 1, the device being configured to determine said time interval by determining a point of intersection between a boundary of the lane and the path of the vehicle, and by calculating the time interval required by the vehicle to reach said point of intersection.

3. The device as claimed in claim 2, in which, if the path of the vehicle has a point of intersection with each of the boundaries of the traffic lane, the device is configured to select the point of intersection closest to the vehicle.

4. The device as claimed in claim 2, the device being configured to calculate a distance to be traveled by the vehicle between its current position and the point of intersection, and to deduce therefrom the time interval required by the vehicle to reach the point of intersection, taking into account the speed of the vehicle and its acceleration.

5. The device according to claim 1, the device being configured to implement steps a. to d. iteratively, and, in a first iteration, to:
estimate the path followed by the vehicle, assuming that the vehicle is in the middle of its traffic lane,
if the time interval is greater than the first determined threshold but less than a second determined threshold greater than the first threshold, determine a lateral movement of the vehicle in its lane and update, for the next iteration, the lateral positions of the boundaries of its traffic lane in relation to the vehicle.

6. The device according to claim 1, configured, if the time interval is less than the first determined threshold, to implement at least one action from the following group:
generate a lane departure warning for a driver of the vehicle,
generate instructions to modify the path of the vehicle in order to keep the vehicle in the lane,
generate instructions to slow down the vehicle.

7. The device according to claim 1, in which the radar is an optical radar.

8. A method for detecting a lane departure of a land vehicle, implemented by a device according to claim 1, the method comprising:
estimating the shape and the position of each boundary of a traffic lane taken by the vehicle, on the basis of the shape and the position of at least one boundary of the road containing the traffic lane,
estimating a path followed by the vehicle,
determining, depending on the shape and the position of the boundaries of the traffic lane, and the path followed by the vehicle, a time interval before the vehicle reaches a boundary of the traffic lane, and
comparing the time interval to a determined threshold and, if the time interval is less than said threshold, determining that the vehicle is in the process of departing from or is going to depart from its traffic lane,
the estimation of the shape and the position of at least one road boundary, by using a clothoid curve, a width of the traffic lanes and the number of traffic lanes of the road, to deduce therefrom the shape and the position of each boundary of the traffic lane taken by the vehicle, being made from data acquired by the radar.

9. A non-transitory computer program product comprising code instructions for implementing the method as claimed in claim 8, when this program is executed by a processor.

10. A non-transitory computer-readable recording medium on which a program is recorded for implementing the method as claimed in claim 8, when this program is executed by a processor.

11. The device as claimed in claim 3, the device being configured to calculate a distance to be traveled by the vehicle between its current position and the point of intersection, and to deduce therefrom the time interval required by the vehicle to reach the point of intersection, taking into account the speed of the vehicle and its acceleration.
